(19) United States
(12) Patent Application Publication
(10) Pub. No.: US 2024/0053728 A1
(43) Pub. Date: Feb. 15, 2024

(54) FIELD DEVICE

(71) Applicant: Samson Aktiengesellschaft, Frankfurt am Main (DE)

(72) Inventors: Torsten Jung, Frankfurt (DE); Jens Bieger, Moerfelden-Walldorf (DE); Thomas Steckenreiter, Rödermark (DE)

(73) Assignee: Samson Aktiengesellschaft, Frankfurt am Main (DE)

(21) Appl. No.: 18/042,738

(22) PCT Filed: Aug. 13, 2021
(86) PCT No.: PCT/EP2021/072640

§ 371 Date: Sep. 29, 2023

(30) Foreign Application Priority Data
Aug. 26, 2020 (DE) 10 2020 122 321.8

(51) Int. Cl. G05B 19/4155

(52) U.S. Cl. CPC G05B 19/4155; G05B 2219/32287; G05B 2219/31119

(57) ABSTRACT

A field device for a process plant, may include a power distributing data switch having an electrical primary connection to consume power at a first power level higher than 10W, and at least two electrical secondary connections for combined data communication and power transfer at a second power level of lower than 10W per secondary connection. The field device may also include a housing to accommodate electrical components safe from dust and/or water, which forms a first housing compartment fitted for pressure proof enclosure of electrical components in an environment with explosive or flammable atmosphere and which accommodates the primary connection. The secondary connections may be arranged outside a pressure proof enclosure and outside the first housing compartment. The device may include a protective bridge to isolate leads out of the first housing compartment to connect the primary connection to the secondary connections.

### CROSS REFERENCE TO RELATED APPLICATIONS

This patent application is a U.S. National Stage application of International Application No. PCT/EP2021/072640, filed Aug. 13, 2021, which claims priority to German Patent Application No. 102020122321.8, filed Aug. 26, 2020, each of which is incorporated herein by reference in its entirety.

### BACKGROUND

### Field

The disclosure relates to a field device for a process plant, such as a chemical plant, for example a refinery, a power plant, for example a nuclear power plant, a food processing plant or the like.

### Related Art

In process plants, different technologies are used for data transmission. Many field devices use a combined connection with two conductors for the combined transmission of signal and power. In the two-conductor connection, a central control unit, for example a central control room of a process plant, transmits a 4-20 mA signal to the field device. In a field device formed as a positioner valve, a 4 mA control signal can cause the positioner valve to move to a closed position, whereas a 20 mA signal can cause the positioner valve to move to a maximum opening position. Signals in the range of 4 to 20 mA can cause the positioner valve to assume a predetermined intermediate position between the closed position and the maximum opening position, which can be proportional to the current signal, for example. A passive field device in the form of a sensor can transmit an analog 4-20 mA signal to a central control unit in order to report a piece of information about a part in a process plant, for example a part or a component of the process plant or a process fluid. A current signal, for example, can be transmitted proportionally to a certain pressure range from a pressure sensor to a certain central control unit. The transmission of information or data, respectively, by means of a 4-20 mA signal is limited to very small amounts of data.

The HART protocol, the FOUNDATION Fieldbus protocol, the PROFIBUS protocol and a number of other digital communication technologies are also commonly used to transmit data in process plants. Since 2007, HART has been part of the fieldbus standard IEC 61158. For data transmission according to the HART protocol, a high-frequency oscillation, for example±0.5 mA, is superimposed on an analogue signal, for example a 4-20 mA signal. This allows to display a digital 1 with a frequency of 1.2 kHz and a digital “0” with a frequency of 2.2 kHz can be displayed. HART allows the transmission of process and diagnostic information as well as control signals between field devices and a superior control unit, for example a central control room.

In some process plants, data is transmitted from a central control unit to field devices using so-called “Power over Ethernet” technology. Power over Ethernet (PoE) refers to a technology which supplies network-compatible devices with power using an 8-wire Ethernet cable. Data transmission by means of PoE is carried out according to IEEE standard 802.3af (July 2003). Power over Ethernet systems are intended to save power supply cables in order to supply network-compatible devices with power in places that are difficult to access or confined. According to the IEEE standard 802.3af, participating devices can be divided into power sourcing equipment (PSE) and power devices (PD). The supply voltage for the power devices is 48V during operation. The maximum power consumption of the devices is 350 mA, whereby up to 400 mA is permitted, resulting in a maximum power consumption of 14.5 W per device. Unassigned wires and/or signal-carrying wires of the Ethernet cable can be used to transmit power. PoE allows the fast transmission of large amounts of data. The power density of PoE technology does not permit its use in explosion-prone areas. The use of PoE technology requires a much higher investment than analogue 4-20 mA communication. Upgrading existing process plants with PoE technology also requires enormous investments, which are uneconomical in many cases. A field device that is supplied with power via an Ethernet connection (Power over Ethernet) and an associated initial operation procedure is described in DE 10 2006 036 770 A1.

An approach to linking data transmission on the one hand via Ethernet and on the other hand by means of established and widespread communication technologies of process plants is realized by the so-called Advanced Physical Layer (APL) technology, in particular according to the IEEE P802.3cg (2016) standard. In contrast to PoE technology, APL technology is intended to be particularly suitable for including network-compatible devices in explosion-prone areas (Zone 0 and 1/Division 1). Zone 0 describes an area in which an explosive gas-air mixture is present permanently or for long periods of time. Zone 1 describes an area in which flammable or conductive dust particles are present, as well as areas in which an explosive gas-air mixture can be present for a short period of time under normal operating conditions. By means of APL technology, it shall also be possible to design field devices to be intrinsically safe. By means of twisted double wires (twisted-core wiring according to 10BASE-T1L), data transmission rates of 10 Mb/s up to 100 Mb/s and higher are to be achieved. From a central control unit to an APL field switch, process plants with APL technology can be equipped with a so-called trunk data and power transmission line, in particular with a length of up to 1000 m. The so-called trunk lines shall be designed to transmit power of up to 54 W. Several field devices with so-called track data and power transmission lines, in particular with a length of up to 200 m, can be connected to the so-called APL field switch. The track lines are set up to provide power of usually 500 mW or lower. The data and power transmission line is usually an IEC 61158 type A fieldbus cable with twisted double pairs and an electrically shielding cladding (also referred to as shield). According to the APL standard IEEE P802.3cg (2016), electrically shielding cables must be used to connect APL field switches with each individual field device. Up to five field devices can be connected to one track line. Several, for example a maximum of 5 up to a maximum of 10 APL field switches can be connected to one trunk line. APL technology is compatible with the operation of field devices in explosion-prone areas. For this purpose, a low power density may be provided to prevent the electrical and/or thermal energy present at a field device from passing above an ignition threshold even under anomalous operating conditions. APL field switches and field devices are designed to be ignition proof (explosion proof) according to protection category “Ex d”.

APL technology allows the transmission of large data volumes and is characterized by compatibility with existing two-wire communication systems. However, many users also complain about the high investment costs for equipping or upgrading a complete plant with APL technology.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a field device according to an exemplary embodiment.

FIG. 2 a system with a field device according to an exemplary embodiment.

FIG. 3 a system with a field device according to an exemplary embodiment.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

It is an object of the disclosure to overcome the disadvantages of the prior art and, in particular, to provide a field device and/or a system that allows safe and cost-effective use in combination with APL technology.

Thus, a field device is provided for a process plant, such as a chemical plant, a refinery for example, a power plant, a nuclear power plant for example, a food processing plant or the like.

The field device comprises a power distributing data switching device. The power distributing data switching device comprises an electrical primary connection configured to consume power at a first power level higher than 10 W, in particular higher than 20 W, preferably higher than 50 W. The electrical primary connection can be referred to as trunk connection. In particular, the electrical primary connection is configured to have a power consumption of no more than 100 W, in particular no more than 75 W, preferably no more than 60 W. For example, the primary connection can be set up for power consumption at a first power level of 54 W. In particular, the electrical primary connection can be set up for combined data communication, especially digital data communication, and power consumption at the first power level.

The power distributing data switching device also has at least two electrical secondary connections for combined data communication, in particular digital data communication, and power transfer at a second power level lower than 10 W, in particular lower than 1 W, per secondary connection. The at least two electrical secondary connections can be set up for power transfer at a second power level of at least 1 mW, at least 10 mW or at least 20 mW. In an exemplary embodiment, one electrical secondary connection, in particular at least two electrical secondary connections, preferably all electrical secondary connections of the power distributing data switching device, can be arranged for combined data communication, in particular digital data communication, and power transfer at a second power level of no more than 0.5 W per secondary connection. A secondary connection may be designated as a track connection.

The power distributing data switching device can in particular have exactly one electrical primary connection. The power distributing data switching device can have at least two, at least five, at least ten and/or no more than 150, no more than 100 or no more than 50 electrical secondary connections.

The field device has a housing for accommodating electrical components safe from dust or water. The housing can be designed, for example, according to protection class IP65 or higher. In particular, the at least two electrical secondary connections are arranged inside the housing. In particular, the electrical primary connection is arranged inside the housing. In particular, the power distributing data switching device is located inside the housing. For example, a housing for dust- and/or water-protected accommodation of electrical components can be defined according to a protection class of the so-called International Protection Code (IP Code). Protection classes can specify the degree of protection of the housing against contact, foreign body, water and the like. IP codes can be defined, for example, according to IEC 529, EN 60529, DIN VDE 0470-1 in the version as amended in 2014. The first digit of the IP code indicates the protection against foreign bodies and contact, whereby a higher value provides a more distinctive protection. The first digit can have the following meaning: 3: protected against solid foreign bodies larger than 2.5 mm and against contact with tools; 4: protected against solid foreign bodies larger than 1 mm and against contact with wire; 5: protected against dust and contact; 6: sealed against dust, protected against contact. The second digit of the IP code concerns protection against water. The second digit can have the following meaning: 3: protected against spraying water; 4: protected against splashing water; 5: protected against jet water; 6: protected against strong jet water; 7: protected against temporary immersion; 8: protected against permanent immersion. For example, the housing can at least correspond to protection class IP 65, at least to protection class IP 66, at least to protection class IP 67 or at least to protection class IP 68.

The housing forms a first housing compartment. The housing can form a second or additional housing compartments. The first housing compartment is designed for pressure proof enclosure of electrical components in an environment with explosive or flammable atmosphere and accommodates the primary connection. In an exemplary embodiment, the first housing compartment fully accommodates the primary connection. In particular, only the first housing compartment is designed for pressure proof enclosure of electrical components in an environment with explosive or flammable atmosphere. An environment with explosive or flammable atmosphere can be, for example, an atmosphere corresponding to Zone 0 or Zone 1. According to one embodiment of a field device, the first housing compartment is confined in at least one section by an outer wall of the housing. In sections, the first housing compartment can be confined by two or more, three or more, in particular four or five outer walls of the housing. A field device with its first housing compartment confined in at least one section by an outer wall of the housing can have a feed-through in this section through the outer wall of the housing, for example, for the entry of a line for connecting it to the electrical primary connection. For example, a tubular encapsulated trunk line can be run through the outer wall for connection to the primary connection. A line routed through the outer wall of the housing into the first housing compartment can be designed, in particular, as IEC 61158 Type A fieldbus cable. A line can be routed to an electrical tertiary connection in the first housing compartment, in particular for combined data communication and power transfer, through the same or another outer wall of the housing confining the housing compartment.

An electrical component is generally a component that is powered by electricity for power and/or data processing during normal operation, or at least can be. An electrical component can, for example, be an electronic computing device, such as a microcontroller or a microprocessor; an electro-pneumatic converter, an analog-to-digital converter, digital-to-analog converter, an electronic signal processing device, a data transmission device and/or a load control device or the like.

A fire and/or explosion resistant passage for a line to connect to the primary connection inside the first housing compartment can be provided in the section of the outer wall of the housing confining the first housing compartment.

In particular, the at least two secondary connections are fully arranged outside of a pressure proof enclosure of electrical components for an environment with explosive or flammable atmosphere. In particular, the at least two secondary connections are arranged outside the first housing compartment. In an exemplary embodiment, all electrical secondary connections for combined data communication, in particular digital data communication, and power transfer are arranged outside a pressure proof enclosure of electrical components for an environment with explosive or flammable atmosphere, in particular outside the first housing compartment. It is possible that a group of electrical secondary connections for combined data communication and power transfer is arranged outside a pressure proof enclosure of electrical components for an environment with explosive or flammable atmosphere and a group of electrical tertiary connections for combined data communication and power transfer is arranged inside a pressure proof enclosure of electrical components for an environment with explosive or flammable atmosphere, in particular in the first housing compartment. The electrical secondary connections of the first group are in particular all set up for power transfer at a second power level of no more than 1 W, in particular of no more than 0.5 W per secondary connection. One electrical tertiary connection or several electrical secondary connections, in particular all electrical secondary connections of the second group, can be set up for power transfer at a third or second power level of lower than 10 W, in particular of no more than 5 W, and higher than 0.5 W, in particular at least 1 W.

According to the disclosure, at least one protective bridge, which in particular isolates potential-free, leads out of the first housing compartment to connect the primary connection to the at least two secondary connections. In an exemplary embodiment, only a connection from the primary connection to the at least two secondary connections is implemented through the protective bridge. For example, the protective bridge from the first housing compartment, where the primary connection is accommodated, can pass to another housing compartment accommodating the at least two secondary connections to connect the primary connection to the secondary connections. The protective bridge permeates the pressure proof enclosure for an environment with explosive or flammable atmosphere, defining the first housing compartment, to allow an electrical connection, particularly for combined data communication and power transfer from the primary connection to the at least two secondary connections. It should be understood that the data communication and power transfer from the primary connection to the at least two secondary connections can be affected indirectly by means of a data switching device and/or a load control device. The protective bridge from the first housing compartment in external direction, in particular into a second housing compartment, is arranged to contain an internal fire or explosion in the first housing compartment and to safely prevent a breakdown or flashover into the exterior space and/or to additional housing compartments, in particular into the second housing compartment.

According to one embodiment of a field device, the housing forms at least one additional housing compartment in which at least one secondary connection is arranged. The at least one additional housing compartment is not arranged as a pressure proof enclosure of electrical components for an environment with explosive or flammable atmosphere. In particular, the additional housing compartment within the housing is arranged for dust- and/or water-protected accommodation of electrical components. In an exemplary embodiment, the housing for dust- and/or water-protected accommodation of electrical components forms the at least one additional housing compartment. The additional housing compartment can have the same or a different protection class, for example IP65, as the first housing compartment.

According to an embodiment of a field device which can be combined with the previous ones, the protective bridge comprises a galvanic isolation, such as an optocoupler and/or an inductive coupler. Alternatively, or additionally, the protective bridge can comprise an electrical line barrier. An electrical line barrier can be arranged in the first housing compartment and limit the power density of the line exiting the first housing compartment by means of the electrical protective bridge in such a way that safe protection against ignition of an explosive or flammable atmosphere outside the first housing compartment is ensured. The protective bridge is designed to prevent electrical flashover from electrical components inside the first housing compartment to electrical components outside the first housing compartment. The protective bridge can include at least one protective device against surges and/or transients. For example, the protective bridge of a field device can have one optocoupler and/or one inductive coupler per each electrical secondary connection.

In particular, the protective bridge of the field device can have one data coupler per secondary connection, for example an optocoupler and/or inductive coupler, for data communication from the primary connection to the respective secondary connection. Alternatively, or additionally, the protective bridge can have one safe power coupler per secondary connection, in particular an inductive coupler, for power transfer from the primary connection to the respective secondary connection. The data coupler and/or the power coupler can have a safety device against surges and/or transients. In particular, the protective bridge implements a floating electrical connection between the at least two electrical secondary connections and the electrical primary connection or between the at least two electrical secondary connections and a possible data switching device and/or load control device. The protective bridge can have at least one data coupler per secondary connection and/or at least one power coupler per secondary connection.

The protective bridge is set up so that each electrical secondary connection has a power level of no more than 10 W, in particular no more than 5 W, preferably no more than 1 W, and, particular, preferably no more than 0.5 W available for data communication and power transfer. A power coupler of the protective bridge can be arranged to provide a power level of at least 10 mW, in particular at least 100 mW, preferably at least 250 mW, to an electrical secondary connection connected to the power coupler. A data coupler can be arranged to provide a power level of no more than 250 mW, in particular no more than 100 mW, preferably no more than 50 mW, and particularly preferred no more than 1 mW, to a secondary connection. Both a data coupler and a power coupler can be connected to the same electrical secondary connection of the field device. According to one embodiment of a field device which can be combined with the previous one, the power distributing data switching device comprises a load control device and a data transmission device, in particular a package data switching device, for transmitting digital data. In particular, the load control device and/or the data transmission device is accommodated in the first housing compartment. The load control device and/or the data transmission device can be accommodated in a housing compartment for pressure proof enclosure of electrical components for an environment with explosive or flammable atmosphere. The load control device, in particular, is connected to the electrical primary connection on the one side and to the at least two electrical secondary connections on the other side. The load control device can be arranged to provide power for transfer at the second power level based on the power input at the first power level. The data transmission device, in particular the package data switching device, can be designed to ensure data communication, in particular digital data communication, from the primary connection to at least one of the at least two secondary connections. On the one hand, the data transmission device can be connected to the primary connection. The data transmission device is connected to the at least two secondary connections in accordance with the signal. The data transmission device can be set up to detect an electrical state present at at least one primary connection and/or secondary connection and/or to provide a predetermined electrical state to at least one electrical primary connection and/or secondary connection. The data transmission device can be designed to convert an electrical state detected at a primary and/or secondary connection into a digital data set. The data transmission device can alternatively or additionally be designed to provide an electrical signal corresponding to a digital data set at one or several primary and/or secondary connections, which can be decoded into the digital data set. The data transmission device can comprise at least one analog-to-digital converter and/or at least one digital-to-analog converter.

In an exemplary embodiment, the data transmission device is set up for bi-directional data communication at the primary connection and/or at the at least two secondary connections, in particular by means of the data transmission device, The data transmission device can implement filtering and/or separation of electrical data signals originating from the primary connection to a specific one of the at least two secondary connections. For example, the data transmission device can be designed to assign data, in particular digital data, received by means of the primary connection to a particular one of the at least two secondary connections based on one or more predetermined criteria. A field device having a load control device and a data transmission device can be configured to isolate electrical power supply from electrical data signals at a first or second power level.

According to another embodiment, which can be combined with the previous one, at least one electronic or mechatronic control circuit device for detecting and/or influencing a process variable of the process plant is arranged in the housing, in particular in the first housing compartment. In particular, the additional and/or supplementary control circuit device is provided with electrical power supplied via the primary connection. The control circuit device can be set up to directly or indirectly detect and/or influence the process variable. A control circuit device can be, for example, a sensor, such as a location sensor, a pressure sensor, a current or flow sensor, a temperature sensor or the like, which generates and transmits a sensor signal based on a process state, for example to a control and/or regulating device. The sensor generates an actual signal for the control and/or regulating device, in particular the control and/or regulating electronics. The control circuit device can comprise control and/or regulation electronics. Control and/or regulation electronics can be set up to process a desired signal received from a superior control unit, for example a central unit, such as a central control room of a process plant, in order to provide a control and/or regulation signal for operating an actuator of the process plant.

Control and/or regulation electronics can be set up to generate a control and/or regulation signal based on a desired signal and an actual signal. Control and/or regulation electronics can be implemented, for example, by a digital positioner controller that has a computing device, a memory device and at least one signal input and at least one signal output. According to a control and/or regulation routine, which can be stored in a memory, the computing device of control and/or regulation electronics can be designed to determine a control and/or regulation signal with a processor or the like on the basis of a desired signal and possibly an actual signal. A control routine can be implemented, for example, according to a PID control routine, a two-point control routine, a three-point control routine or the like, or a combination thereof. Control and/or regulation electronics can be arranged to apply the control routine. The control circuit device can comprise a converter, for example an electro-pneumatic converter. An electro-pneumatic converter can be designed to provide a respective pneumatic control and/or regulating signal based on an electrical control and/or regulating signal, in particular for a pneumatic actuator. The field device according to this embodiment is particularly suitable for uses where only confined installation space is available. By accommodating both the primary connection and at least one control circuit device as well as, if applicable, a data transmission device and/or a load control device in one, in particular the same first housing compartment for pressure proof enclosure of the aforementioned electrical components in an environment with explosive or flammable atmosphere, the effort required to secure the several electrical components can be significantly reduced and thus costs saved.

According to a particular embodiment of a field device for a process plant, such as a chemical plant, for example a refinery, a power plant, a nuclear power plant for example, a food processing plant, or the like, which has a housing for dust- and/or water-protected accommodation of electrical components both a power distributing data switching device with a primary connection and at least two electrical secondary connections and at least one electronic or mechatronic control circuit device for detecting and/or influencing a process variable of a process plant are accommodated in the housing. In particular, the power distributing data switching device accommodated in the housing can be an APL field switch.

The particular embodiment of the field device can comprise an electrical primary connection configured for power consumption at a first power level higher than 10 watts. In the particular embodiment of the field device, at least two electrical tertiary connections can be provided in the housing for combined data communication and power transfer at a second power level lower than 10 watts per secondary connection. In the particular embodiment of the field device, the in particular additional electronic or mechatronic control circuit device can in particular be supplied exclusively with electrical power supplied via the primary connection. This particular embodiment of the field device can be combined in any way with the previous embodiments as well as the embodiments described below. The particular embodiment of a field device can be implemented in particular by a field device which accommodates both a power distributing data switching device in the form of an APL field switch, in particular in accordance with IEEE P 802.3cg, and a control circuit device for detecting and/or influencing a process variable of the process plant in the same housing for protection against dust and/or water.

According to a further development, the control circuit device is supplied with electrical power by means of the load control device, via a tertiary connection which is, in particular, set up for combined data communication, in particular digital data communication, and power transfer at the second power level lower than 1 watt, in particular not more than 0.5 watt, and which is accommodated in the first housing compartment.

According to a further development, the control circuit device is a controller for regulating a positioner. The controller has at least one signal input for receiving an actual signal, such as an actual position signal, with respect to the positioner and an output for operating the positioner. The positioner can be a device designed for controllable intervention in a technical process. The positioner is preferably located outside the housing. The positioner can have its own positioner housing, which is designed to accommodate electrical positioner components in a dust- and/or water-protected manner. The positioner housing can be designed for pressure proof enclosure of electrical positioner components for an environment with explosive or flammable atmosphere.

The positioner can be intrinsically safe. An intrinsically safe positioner or another intrinsically safe electrical component can be designed to be intrinsically safe in such a way that no unsafe state occurs even in the event of an error that deviates from normal operation. For example, an error describes a situation for which there is a risk of ignition or other risk: For example, the possibility of sparking upon closing an electrical circuit in an explosion-prone area may be considered a risk. An intrinsically safe positioner or other electronic component can be designed in accordance with the ignition protection type intrinsic safety (“Ex i”, for example, according to IEC-EN 60079-11 part 11, part 14 and/or part 25). An intrinsically safe positioner or other intrinsically safe electronic components are designed in such a way that the applied current and voltage are limited in such a way that ignition of explosive fuel/air mixtures by both sparks and heating is excluded, in particular during normal operation, for example when components are connected and/or disconnected, and/or in the event of an error, for example in the event of a wire breakage or a short circuit. A limitation of the voltage can be affected, for example, by an electrical resistance, a Zener barrier and/or an electronic current limiting device of the intrinsically safe electronic component or the intrinsically safe positioner.

According to another further development of the field device, the control circuit device is arranged within the first housing compartment and has a pneumatic output arranged within the first housing compartment for operating a pneumatic actuator, in particular a pneumatic actuating drive. The pneumatic output of the control circuit device as well as, if applicable, a pneumatic supply access of the same control circuit device can be implemented by a protected pneumatic air passage. A protected pneumatic air passage ensures pressure proof enclosure of electrical components of the field device in the first housing compartment for an environment with explosive or flammable atmosphere. The protected pneumatic air passage can be implemented in the section of the first housing compartment, implemented by an outer wall of the housing. A pneumatic actuating drive is provided, for example, for operating a positioner valve or the like.

According to another further development of the field device, the control circuit device comprises a location sensor arranged within the first housing compartment for detecting the position of the positioner. The position sensor is in particular configured to detect the position of a positioner rod or a positioner shaft of the positioner. In an exemplary embodiment, the positioner rod or positioner shaft is arranged exclusively completely outside the first housing compartment, in particular completely outside the housing.

In particular, the location sensor is coupled contact-free with the positioner. In particular, the contact-free coupling can comprise a magnetic and/or electromagnetic coupling. The contact-free coupling preferably comprises at least one magnet or electromagnet, in particular fixedly connected to the positioner rod or positioner shaft of the positioner, preferably fixedly attached thereto, and a magnet-sensitive sensor, such as an AMR, which is accommodated within the first housing compartment, and cooperating with the magnet or electromagnet. It should be understood that instead of contact-free magnetic or electromagnetic coupling, the person skilled in the art can use another suitable contact-free type of coupling, such as optical coupling.

Alternatively, or additionally, the location sensor is mechanically coupled with the positioner. The outer wall of the housing can comprise a feed-through for mechanical coupling. For example, the mechanical coupling of the location sensor can comprise a sensor shaft and the outer wall of the housing can comprise a rotary feed-through for the sensor shaft. The sensor shaft can extend out of the first housing compartment into its unprotected environment to the positioner, in particular to the positioner rod or positioner shaft. The sensor shaft is mechanically connected to the positioner, in particular to the positioner rod or positioner shaft. The rotational feed-through ensures pressure proof enclosure of electrical components of the field device in the first housing compartment vis-a-vis to an environment with explosive or flammable atmosphere.

The disclosure also relates to a system comprising a field device as previously described and a positioner, in particular a positioner valve, having at least one converter in particular an electro-pneumatic converter and/or an actual signal transmitter, such as a location or position sensor arranged outside the housing of the field device and which has an electrical signal input and/or output connected to a secondary connection of the field device. The converter is preferably intrinsically safe. The converter comprises an electrical signal input and/or output, which is set up for data and/or power transmission via an external line. At least one, in particular exactly one, external line for data and/or power transmission is provided between a secondary connection, in particular exactly one secondary connection, of the positioner and the converter. The external line for data and/or power transmission connects the converter arranged outside the housing to the electrical secondary connection arranged in particular inside the housing, preferably in an additional housing compartment, for uni- or bi-directional data transmission and/or for uni- and bi-directional power transmission. In an exemplary embodiment, the converter comprises a converter housing for dust- and/or water-protected accommodation of electrical components of the converter. In particular, the converter housing is designed for pressure proof enclosure of electrical converter components for an environment with explosive or flammable atmosphere. For example, a housing for pressure proof enclosure can be an explosion-proof housing.

The converter can be set up to receive electrical signals from the field device, for example analogous signals, and to convert them into data signals, in particular control and/or regulation signals for a positioner, or for example into, pneumatic control and/or regulation signals for a pneumatic positioner. The converter can be configured to generate a data signal for the field device based on a process state. For example, the converter can be a location or position sensor, a pressure sensor, a flow sensor, a temperature sensor, or the like, which detects a process state, such as a position, pressure, temperature, current velocity, current volume, vibration, or the like, and which generates a corresponding data signal for transmission to the field device. The data signal generated by the converter is based on a process state and is in particular an actual signal. In an exemplary embodiment, the external line for data and/or power transmission is designed as a simple two-core cable free of tubular electrical encapsulation for an environment with explosive or flammable atmosphere.

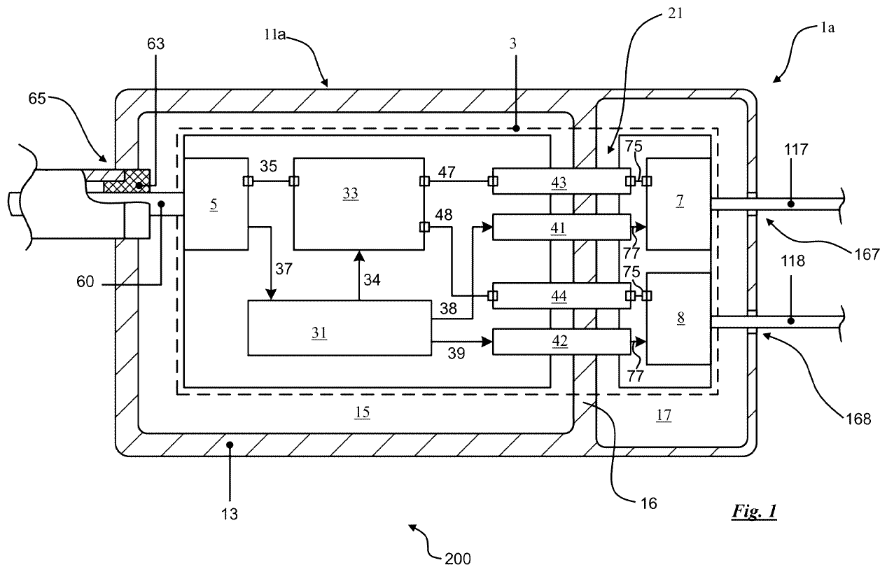

In an exemplary embodiment, the field device 1a comprises a power distributing data switching device 3 with an electrical primary connection 5 and at least two electrical secondary connections 7, 8, as well as a housing 11a for dust- and/or water-protected accommodation of electrical components, which forms a first housing compartment 15 accommodating the primary connection 5. The at least two secondary connections 7, 8 are accommodated in an additional housing compartment 17 of the housing 11a. In the exemplary embodiment of a field device 1a shown in FIG. 1, the electrical components 5, 7 and 8 of the power distributing data switching device 3 are altogether accommodated within the housing 11a in such a way that they are protected from dust and/or water from the environment of the field device, in particular in accordance with protection class IP-65 or higher.

The first housing compartment 15, which completely accommodates the primary connection 5, is designed for pressure proof enclosure of electrical components located therein for an environment 200 with explosive or flammable atmosphere, whereas the additional housing compartment 17, which accommodates the secondary connections 7, 8, is not.

The electrical primary connection 5 is configured for power consumption at a first power level of higher than 10 watts. In particular, the electrical primary connection 5 can be implemented for power consumption at a first power level of 45 watts and/or in accordance with the APL standard IEEE P 803.2cg as a so-called trunk connection. The individual electrical secondary connections 7 or 8 or potentially additional secondary connections (not shown in detail) are designed for combined data communication and power transfer at a second power level lower than 10 watts per secondary connection, in particular no more than 5 watts per secondary connection, preferably no more than 0.5 watts per secondary connection.

The housing 11a has outer housing walls 13 which separate the internal space of the housing 11a, which is divided into compartments 15, 17, from the environment 200 of the field device 1a. The housing walls 13 can, for example, be designed with seals to comply with the protection class IP-65. Only the first housing compartment 15 is also pressure proof for an environment with an explosive or flammable atmosphere, so that an explosion, fire or spark on the inside of the first housing compartment 15 does not have any harmful effects on the environment 200 outside the first housing compartment 15. Even if the environment 200 outside the first housing compartment 15 is filled with a flammable or explosive gas according to the so-called Zone 0 or Zone 1, the encapsulation of the first housing compartment 15 ensures that an ignition source or even an ignition on the inside of the first housing compartment 15 does not have an effect onto the environment 200 outside the first housing compartment 15. This allows the usage of electrical components inside the first housing compartment 15, such as the electrical primary connection 5, which are not intrinsically safe because the power density available to them exceeds a permissible limit, for example. The enclosure implemented by the first housing compartment 15 ensures that an internal fire or explosion, or an electrical breakdown or flashover into the external space 200 or the additional housing compartment 17 would be safely prevented.

The additional housing compartment 17 is located in the environment 200 outside of the first housing compartment 15. A gas or gas mixture which is flammable or explosion-prone can be present within the second housing compartment 15. The electrical components arranged within the second housing compartment 17, for example the electrical secondary connections 7, 8 are designed for combined data communication power transfer, in particular intrinsically safe, for power transfer at a power level of lower than 10 watts per secondary connection, in particular lower than 1 watt, preferably not more than 0.5 watt.

The interior of the housing 11a is divided into the first housing compartment 15 on the one hand and the additional housing compartment 17 on the other hand by an inner housing wall 16. The protection class against dust and water can be the same for all compartments 15, 17, etc. of the housing 11a. Alternatively, it is conceivable that the first housing compartment 15 and the additional housing compartment 17 are conceptualized against dust and water according to different protection classes, wherein in particular the first housing compartment 15 can correspond to the protection classes' higher dust and/or water tightness than the additional housing compartment 17.

A load control device 31 and a data transmission device 33 are connected to the electrical primary connection 5 located within the first housing compartment 15. In the schematic representation according to FIG. 1, bi-directional data connections are depicted by lines with square ends. In the schematic representation according to FIG. 1, electrical power supply lines are depicted as lines with the end of the arrow pointing towards a power device. The direction of the power flow is illustrated by the direction of the arrow. The data transmission device 33 is connected to the primary connection 5 via a bi-directional data transmission line 35 for the transmission of digital data, in particular. The load control device 31 is supplied with electrical power via a supply line 37 originating from the primary connection 5. Originating from the load control device 31, electrical components of the data switching device 3 are supplied with electrical power via various supply lines 36, 38, 39.

A protective bridge 21 leads through the inner housing wall 16 from the first housing compartment 15 to the electrical secondary connections 7 and 8. In contrast to a simple electrical connection line and through the usage of safe data and/or power couplers 41, 42, 43, 44, the protective bridge 21 ensures that outside the first housing compartment 15, for example, in accordance with the criteria of intrinsic safety, protection against ignition and/or explosion is provided around the electronic components located therein. The data couplers 43, 44 and the power couplers 41, 42 can include galvanic isolation, for example. The data couplers 43 and 44 can be implemented as optocouplers or inductive couplers, for example. The power couplers 41, 42 can be implemented as inductive couplers, for example. It is conceivable that a data and/or power coupler 41, 42, 43 and/or 44 comprises an electrical power barrier.

A data coupler 43, 44 connects the respective secondary connection 7, 8 with the data transmission device 33 for data communication. In the first housing compartment 15 an inner data line 47 is provided between the first data coupler 43 and the data transmission device 33. The first data coupler 43 is connected to the first secondary connection 7 with an outer data line 75 in the second housing compartment 17. In the first housing compartment 15, the second data coupler 44 is connected to a data transmission device 33 with an inner data line 48 and in the additional housing compartment 17, it is connected to the second secondary connection 8 with an outer data transmission line 75.

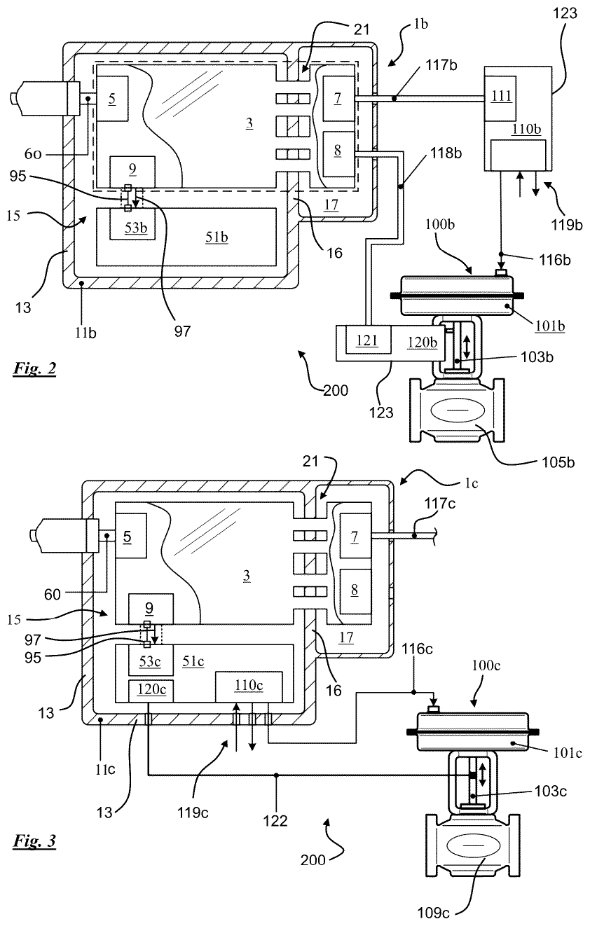

Internal supply lines 38, 39 lead from the load control device 31 to the first power coupler 41 and the second power coupler 42, respectively. The first power coupler 41 is connected to the first secondary connection 7 by an external supply line 77. The second power coupler 42 is connected to the second secondary connection 8 with an external supply line 77. External lines for data and/or power transmission 117a, 118a are connected to the secondary connections 7 and 8 outside the housing 11a. One or more components of the process plant, for example a positioner controller or a location sensor, can be connected to each of the external lines 117, 118. Such a connection is described in detail below in the second embodiment of a field device 1b with respect to FIG. 2. The external lines 117a, 118a are guided out of the housing 11 through a respective passage 167, 168, which is designed without particular protection (apart from protection against water and/or dust).

A passage 65 for a primary line 60 for power and data transmission is provided in a section 13 of the housing 11a surrounding the first housing compartment 15. The primary line 60 for data and power transmission is connected to the primary connection 5. The primary line 60 is surrounded by a tubular encapsulation 63, and thereby designed for safe use in an environment with explosive or flammable atmosphere. By insertion of the tubular encapsulation 63 into the passage 65 in the outer housing wall 13 the safe enclosure of the first housing compartment 15 is not impaired. For example, the primary line 60 can be a so-called trunk line. In particular, the primary line 60 can be designed as a protected two-core shielded cabling according to IEC 61158 type A fieldbus cable with a protective sheath.

FIGS. 2 and 3 show different embodiments of field devices 1b, 1c. The field devices 1b and 1c differ from the field device according to FIG. 1a primarily only in that at least one electronic or mechatronic control circuit device 51b, 51c is accommodated within the first housing compartment 15 in addition to the electrical components primary connection 5, power distributor 31 and data transmission device 33. In the field devices 1b and 1c according to FIGS. 2 and 3, the additional control circuit device 51b, 51c is safely protected in an environment 200 with an explosive or flammable atmosphere by being accommodated within the pressure proof enclosure implemented by the first housing compartment 15. With regard to the further design of the field device 1b or 1c and in particular of the power distributing data switching device 3, reference is made to the above embodiments with regard to the field device 1a shown in FIG. 1.

FIG. 2 shows a field device 1b with a housing 11b containing an electronic control circuit device 51b, which is set up as a controller, namely as a positioner controller for a positioner 100b, in addition to the power distributing data switching device 3, which in the embodiments with a tertiary connection 9 can be designed as an APL field switch, for example.

The positioner is exemplified here as a pneumatically operated positioner valve 100b. The pneumatically operated positioner valve 100b comprises a pneumatic positioner actuator 101b and a positioner valve 105b, which is operated by the pneumatic positioner actuator 101b by means of a force-transmitting positioner rod 103b. According to an alternative embodiment, a positioner valve can include a positioner shaft for a rotationally movable valve (not shown in detail). The positioner controller 51b is connected to the power distributing data switching device 3 via a tertiary connection 9. The tertiary connection 9 of the power distributing data switching device 3 can be formed as a conventional track connection, for example. The tertiary connection is provided inside the first housing compartment 15 of the field device 1b. The tertiary connection 9 is set up for combined data communication, in particular digital data communication, and power transfer at a second power level of not more than 10 watts, in particular not more than 1 watt, preferably not more than 0.5 watt. It should be understood that a field device can have a different, higher number of secondary connections 7, 8 and/or tertiary connections 9. The tertiary connection 9 has a data transmission line 95 and a supply line 97 for transmitting electrical power from the data switching device 3 to the control circuit device 51b.

The control circuit device 51b has a connection interface 53b which acts as a power input as well as a signal input and/or output. With its signal input 53b, the positioner controller 51b can receive an actual signal such as an actual position signal from a location sensor 120b of the pneumatic positioner 100b. The positioner controller can eject a control and/or regulation signal for the positioner valve 100b at the signal output 53b of the positioner controller 51b. At the signal input 53b, the positioner controller 51b can also receive a target signal from another, central control device, for example, such as a central control room of a process plant, whereby such a target signal can be provided to the field device 1b by means of the primary line 60. The input 53b of the positioner controller 51b is connected to the tertiary connection 9 for supplying power to the positioner controller 51b.

An electro-pneumatic converter 110b is arranged outside the housing 11 of the field device 1b for generating a pneumatic control signal based on an electric control signal from the positioner controller 51b. The electro-pneumatic converter 110b has its own converter housing 123. The electro-pneumatic converter is connected to the pneumatic actuating drive 101b, a single-acting pneumatic actuating drive with spring reset, by a pneumatic line 116b. The electro-pneumatic converter 110b further comprises a ventilation and/or degassing port 119b for connection to a source or sink of pressurized air, respectively.

The electro-pneumatic converter 110b is intrinsically safe. The electro-pneumatic converter 110b has an electrical signal input 111, which is connected to the first secondary connection 7 of the field device 1b via an external line for data and/or power transmission 117b. The control signal of the positioner controller 51b is transmitted to the electro-pneumatic converter 110b by means of the secondary connection 7 via the first external line 117b. The line for data transmission 117b can be designed uni-directionally if the electro-pneumatic converter 110b, for example, does not have the capacity to generate its own communication signals, i.e. is not able to return signals to the field device 1b. Alternatively, the data transmission line 117b from the electro-pneumatic converter 110b to the field device 1b can be bi-directional, so that the electro-pneumatic converter 110b can transmit signals, for example actual signals related to a supply pressure or a diagnostic code of a field device 1b, for example. Signals from the electro-pneumatic converter 110b can be transmitted from the data switching device 3 via the primary connection 5 and/or the tertiary connection 9 to other electronic components, such as a central control room or the positioner controller 51b.

As an additional converter, a location sensor 120b is provided in the system illustrated in FIG. 2, which detects an absolute or relative position of the positioner rod 103b in order to generate an actual position signal on this basis, in order to communicate this to the positioner controller 51b. The location sensor 120b has a signal output 121 for transmitting the actual position signal by means of a second external line 118b for data and/or power transmission 118b. The line 118b connects the second secondary connection 8 of the field device 1b to the signal output 121 of the location sensor 120b. The location sensor 120b is enclosed in a separate converter housing 123.

A positioner or converter housing 123 can be designed to shield the electrical components contained therein against dust and/or water with regard to the environment 200. Additionally, or alternatively to pressure proof enclosure of the electrical converter components contained therein, the converter housing 123 can be adapted to an environment 200 with explosive or flammable atmosphere. The actual position signal generated by the location sensor 120b is transferred by the data switching device 3 to the positioner controller 51b via the data line 95 between the tertiary connection 9 and the signal input 53b. Additionally or alternatively, the data switching device 3 can be designed to transmit an actual signal from a sensor, such as the actual position signal from the location sensor 120b, to other components, such as a central control room, via the primary connection 5 and the primary line 60 connected thereto.

FIG. 3 shows a further embodiment of a field device 1c, which comprises an additional control circuit device 51c within the housing 11c in addition to the power distributing data switching device 3. In the exemplary embodiment shown here, the control circuit device 51c is implemented as a controller for regulating a positioner 100c, namely, in the example of FIG. 3, as a pneumatic positioner 51c for the pneumatically operated positioner valve 100c. The controller 51c has a specially designed signal input 120c for receiving an actual signal, namely an actual position signal with respect to the positioner 100c. The signal input 120c is connected to the positioner 100c via an external line 122. The external line 122 can be surrounded by a tubular encapsulation not shown in detail herein. The line 122 is guided out of the first housing compartment 15 of the housing 11c to connect the signal input 120c to the positioner 100c. The exit of the external line 122 can be designed as a safe passage through an outer wall 13 of the housing 11c surrounding the safe compartment 15, so that it does not compromise the pressure proof enclosure of electrical components for an environment 200 with explosive or flammable atmosphere implemented by the first housing compartment 15. For example, the external line 122 can connect the signal input 120c to a stop sensor on the valve rod 103c which detects an opening position and/or a closed position of the valve 105c.

The electro-pneumatic positioner controller 51c further comprises an electro-pneumatic converter 110c formed as part of the electro-pneumatic converter 51c and which is accommodated within the first housing compartment 15. For connection to a source and/or sink of compressed air, the outer wall 13 of the housing 11c is equipped with secured pneumatic openings 119c. Another safe pneumatic opening through the outer wall 13 of the housing 11c is provided for a pneumatic supply line 116c for operating the pneumatic actuator 101c through the electro-pneumatic converter 110c.

It should be understood that, as an alternative to the embodiments described above, other alternatives, for example combinations, can also be realized, in which, for example, an electro-pneumatic positioner, not shown in further detail, is implemented with an actual signal input arranged within the first housing compartment 15, which is connected via an external line to a status sensor arranged on the positioner, whereby the electro-pneumatic converter of the positioner is arranged outside the housing of the field device.

Alternatively, an electro-pneumatic converter of an electro-pneumatic positioner controller can be accommodated inside the first housing compartment 15 and a status sensor can be connected indirectly to the positioner controller via a secondary connection (not shown in further detail).

According to another conceivable alternative, the field device can be equipped with a contact-free inductive location or position sensor, for example, located therein, and be arranged closely to a positioner rod or positioner shaft. In particular, a magnet or similar contact-free position signal transmitter can be positioned on the positioner rod or positioner shaft and a contact-free location sensor in the first housing compartment 15 for detecting the actual position of the positioner (not shown in detail). It is conceivable that such a field device can have an electro-pneumatic converter for operating a pneumatic drive positioner valve, which may be located either inside the first housing compartment or outside the first housing compartment.

According to a further alternative embodiment, not shown in detail, which can be combined with the aforementioned, a location sensor can be provided within the first housing compartment, which is connected to the positioner rod or positioner shaft by means of mechanical coupling in order to detect an actual position of the positioner. In particular, the positioning movement of the positioner rod or positioner shaft can be converted into a rotary movement of a sensor shaft and the rotation can enter the first housing compartment 15 by means of a rotary feed-through for the sensor shaft. The rotational movement of the sensor shaft can then be absorbed by means of the location sensor, for example a location sensor sensitive to magnetic fields.

It should be understood that, as an alternative to the electro-pneumatic converter described and illustrated herein for operating a pneumatic drive, an electrical supply output can be provided as appropriate in combination with an electric control output for operating an electric actuator. An electric positioner actuator can, for example, power a positioner rod or positioner shaft or a pump.

The features disclosed in the above description, the figures, and the claims can be significant for the realization of the disclosure in its various embodiments both individually and in any desired combination.

### REFERENCE LIST

1a, 1b, 1c field device
3 power distributing data switching device
5 primary connection
7, 8 secondary connection
9 tertiary connection
11a, 116, 11c housing
13 outer housing wall
15 first housing compartment
16 inner housing wall
17 additional housing compartment
21 protective bridge
31 load control device
33 data transmission device
35 data transmission line
36, 37, 38, 39 supply line
41, 42 data coupler
43, 44 power coupler
51b, 51c control circuit device
53b, 53c signal input and/or output
60 primary line
63 tubular encapsulation
65 passage
75 data transmission line
77 supply line
100b, 100c positioner
101b, 101c pneumatic actuating drive
103b, 103c positioner rod
105b, 105c positioner valve
110b, 110c electro-pneumatic converter
111, 112 signal input and/or output
116c pneumatic signal output
117a, 118a external data and/or power transmission line
117b, 118b external data and/or power transmission line
117c external data and/or power transmission line
119c safe pneumatic opening
120b location sensor
121 signal output
122 line
123 positioner or converter housing
167, 168 passage
200 environment

1. A field device for a process plant, comprising:
a power distributing data switch having an electrical primary connection, configured to consume power at a first power level higher than 10 W, and at least two electrical secondary connections configured to provide combined data communication and power transfer at a second power level lower than 10 W per secondary connections;
a housing configured to accommodate electrical components safe from dust and/or water and including a first housing compartment configured as a pressure proof enclosure of electrical components for an environment with explosive or flammable atmosphere, and to accommodate the primary connection, wherein the at least two secondary connections are arranged outside of the pressure proof enclosure of electrical components for an environment with explosive or flammable atmosphere, in particular outside of the first housing compartment; and
at least one protective bridge; configured to isolate leads out of the first housing compartment to connect the primary connection to the at least two secondary connections.

2. The field device according to claim 1,
wherein the housing further comprises at least one additional housing compartment configure to house at least one of the at least two secondary connections.

3. The field device according to claim 1, wherein the first housing compartment is confined in at least one section by an outer wall of the housing).

4. The field device according to claim 1, wherein the protective bridge comprises a galvanic isolation.

5. The field device according to claim 1, wherein the power distributing data switch comprises a load controller and a data transmitter, the load controller and/or the data transmitter being accommodated in the first housing compartment.

6. The field device according to claim 1, wherein the housing is configured to accommodate at least one electronic or mechatronic control circuit configured to detect and/or influence a process variable of the process plant.

7. The field device according to claim 6, wherein the control circuit is supplied with electrical power by a load controller of the power distributing data switch.

8. The field device according to claim 6, wherein the control circuit his a controller configured to regulate a positioner, the controller including:
at least one signal input configured to receive a signal corresponding to a property of the positioner, and
an output configured to operate the positioner.

9. The field device according to claim 8, wherein the control circuit comprises a pneumatic output arranged within the first housing compartment and configured to operate a pneumatic actuator.

10. The field device according to claim 6, wherein the control circuit comprises a location sensor arranged within the first housing compartment and configured to detect a position of the positioner, the location sensor being coupled contact-free and/or mechanically to the positioner.

11. A system comprising:
a field device including:
a power distributing data switch having an electrical primary connection configured to consume power at a first power level higher than 10 W, and at least two electrical secondary connections configured to provide combined data communication and power transfer at a second power level lower than 10 W per secondary connection,
a housing configured to accommodate electrical corn orients safe from dust and/or water and including a first housing compartment configured as a pressure proof enclosure of electrical components for an environment with explosive or flammable atmosphere, and to accommodate the primary connection, wherein the at least two secondary connections are arranged outside of the pressure proof enclosure of electrical components for an environment with explosive or flammable atmosphere, in particular outside of the first housing compartment, and
at least one protective bridge configured to isolate leads out of the first housing compartment to connect the binary connection to the at least two secondary connections, and
a positioner with at least one converter arranged outside of the housing, the positioner including an electrical signal input and/or output connected to one of the at least two secondary connections of the field device.

12. The field device according to claim 1, wherein the at least two secondary connections are arranged outside of the first housing compartment.

13. The field device according to claim 4, wherein the galvanic isolation is an optocoupler, an inductive coupler, and/or an electrical power barrier.

14. The field device according to claim 6, wherein the primary connection is configured to supply the control circuit with electrical power.

15. The field device according to claim 7, wherein the control circuit is supplied with electrical power by the load controller via a tertiary connection accommodated in the first housing compartment, the tertiary connection being configured to provide combined data communication and power transfer at the second power level lower than 10 W.
